(19) United States
(12) Patent Application Publication
(10) Pub. No.: US 2002/0005479 A1
(43) Pub. Date: Jan. 17, 2002

(54) Ion trap mass spectrometer and it's mass spectrometry method

(76) Inventors: Kiyomi Yoshinari, Hitachi (JP); Katsuhiro Nakagawa, Hitachiohta (JP); Yoshiaki Kato, Mito (JP)

Correspondence Address: Edward W. Greason, Kenyon & Kenyon, One Broadway, New York, NY, 10004, US

(21) Appl. No.: 09/798,140

(22) Filed: Mar. 2, 2001

(30) Foreign Application Priority Data
Jun. 7, 2000 (JP) 2000-175544

(51) Int. Cl. H01J 49/00; B01D 59/44

(52) U.S. Cl. 250/288

(57) ABSTRACT

The present invention provides an ion trap mass spectrometry method and its mass spectrometer of an internal ionization type for ejecting ions generated in a large amount when ionizing specimen gas or reagent gas by electron impact ionization (EI) or others in the ion trap from the space between the ion trap electrodes, trapping negative ions generated only in an extremely small amount in priority, and making an analysis in high sensitivity. During the ionization period for ionizing specimen gas or reagent gas by electron impact ionization (EI) or others in the ion trap, a static field is superimposed between the ion trap electrodes in addition to the RF field, and positive ions are made unstable and ejected from the space between the ion trap electrodes simultaneously with ionization, and negative ions generated only in an extremely small amount are trapped in priority, and a mass analysis is made.

### BACKGROUND OF THE INVENTION

The present invention relates to an art for enabling mass analysis of negative ions in an ion trap mass spectrometer of a type of ionizing specimen gas or reagent gas in an ion trap (hereinafter, referred to as an internal ionization type).

Conventionally, as described in Japanese Patent Application Laid-Open 1-239752 or Japanese Patent Application Laid-Open 1-258353, in an ion trap mass spectrometer of an internal ionization type, only positive ions are subjected to mass analysis and negative ions are not analyzed.

When negative ion analysis is necessary, as described in Japanese Patent Application Laid-Open 10-12188 and Japanese Patent Application Laid-Open 11-64282, negative ions are generated outside the ion trap electrode and those ions are injected and analyzed in the ion trap.

### SUMMARY OF THE INVENTION

An object of the present invention is to provide an ion trap mass spectrometry method and its mass spectrometer for enabling analysis of negative ions in an ion trap mass spectrometer of an internal ionization type.

The ion trap mass spectrometry method of the present invention includes, for example, any of the following processes.

Process (1): During the ionization period by EI or others, a static field is superimposed between the ion trap electrodes in addition to the RF field and positive ions are ejected from the space between the ion trap electrodes at the same time with ionization.

Process (2): During the ionization period, a supplementary AC field is additionally superimposed between the ion trap electrodes in addition to the RF field and static field and positive ions are ejected from the space between the ion trap electrodes at the same time with ionization.

Process (3): The magnitude of the static field to be applied during the ionization period is set depending on the polarity (positive or negative) of ions to be subjected to mass analysis.

The ion trap mass spectrometer of the present invention has a constitution, for example, capable of executing any of the aforementioned processes. For example, the ion trap spectrometer has a controller for setting the size of the aforementioned RF field, the size of the aforementioned static field, and the size and/or frequency of the aforementioned supplementary AC field when it is superimposed variable.

The present invention is not limited to the aforementioned contents and it will be further explained hereunder.

### BRIEF DESCRIPTION OF THE DRAWINGS

FIG. 1 is a schematic view of the whole ion trap mass spectrometer of the first embodiment of the present invention;

FIG. 2 is a cross sectional view of each electrode of the ion trap of the first embodiment of the present invention;

FIG. 3 is a stability diagram of values a and q for deciding the stability of the ion orbit in the ion trap;

FIG. 4 is a basic sequence diagram of mass analysis by an ion trap mass spectrometer of an internal ionization type;

FIG. 5 is a basic sequence diagram of the mass analysis process of the first embodiment of the present invention;

FIG. 6 is an illustration for contents of the first embodiment of the present invention in a stability diagram;

FIG. 7 is a drawing showing results of numerical analysis of the mass range of trapped positive and negative ions in the ion trap when the first embodiment of the present invention is adopted;

FIG. 8 is a basic sequence diagram of the mass analysis process of the second embodiment of the present invention;

FIG. 9 is an illustration for contents of the second embodiment of the present invention in a stability diagram;

FIG. 10 is a drawing showing results of numerical analysis of the mass range of trapped positive and negative ions in the ion trap when the second embodiment of the present invention is adopted;

FIG. 11 is a schematic view of the whole ion trap mass spectrometer of the third and fifth embodiments of the present invention;

FIG. 12 is a cross sectional view of each electrode of the ion trap of the third embodiment of the present invention;

FIG. 13 is a basic sequence diagram of the mass analysis process of the third embodiment of the present invention;

FIG. 14 is an illustration for contents of the third to fifth embodiments of the present invention in a stability diagram;

FIG. 15 is a drawing showing results of numerical analysis of the mass range of trapped positive and negative ions in the ion trap when the third embodiment of the present invention is adopted;

FIG. 16 is a schematic view of the whole ion trap mass spectrometer of the fourth embodiment of the present invention;

FIG. 17 is a cross sectional view of each electrode of the ion trap of the fourth embodiment of the present invention;

FIG. 18 is a basic sequence diagram of the mass analysis process of the fourth embodiment of the present invention;

FIG. 19 is a drawing showing results of numerical analysis of the mass range of trapped positive and negative ions in the ion trap when the fourth embodiment of the present invention is adopted;

FIG. 20 is a cross sectional view of each electrode of the ion trap of the fifth embodiment of the present invention;

FIG. 21 is a basic sequence diagram of the mass analysis process of the fifth embodiment of the present invention;

FIG. 22 is a drawing showing results of numerical analysis of the mass range of trapped positive and negative ions in the ion trap when the fifth embodiment of the present invention is adopted;

FIG. 23 is a schematic view of the whole ion trap mass spectrometer of the sixth embodiment of the present invention;

FIG. 24 is a basic sequence diagram of the mass analysis process of the sixth embodiment of the present invention;

FIG. 25 is an illustration for contents of the sixth embodiment of the present invention in a stability diagram;

FIG. 26 is a drawing showing results of numerical analysis of the mass range of trapped negative ions in the ion trap when the sixth embodiment of the present invention is adopted.

FIG. 27 is a schematic view of the whole ion trap mass spectrometer of the seventh embodiment of the present invention; and

FIG. 28 is a basic sequence diagram of the mass analysis process of the seventh embodiment of the present invention.

### DESCRIPTION OF THE PREFERRED EMBODIMENTS

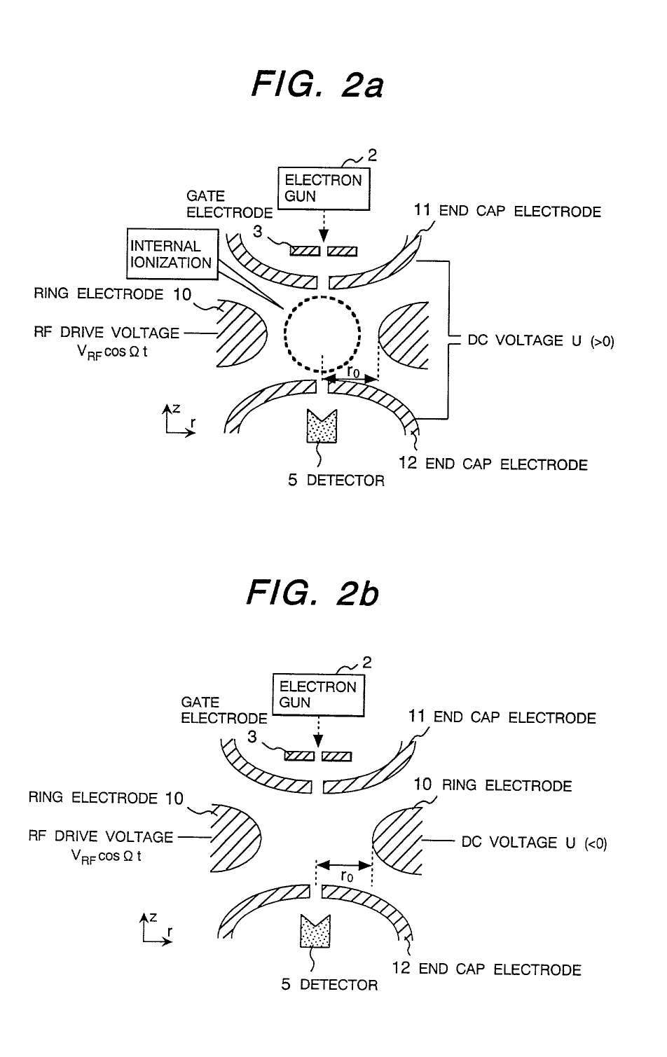

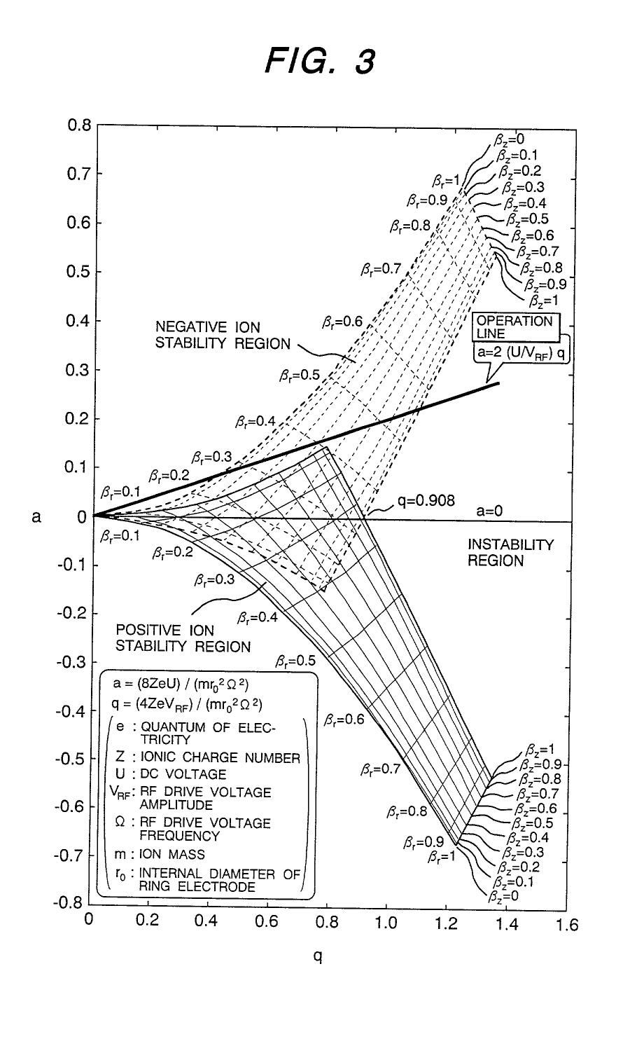

The embodiments of the present invention will be explained hereunder with reference to the accompanying drawings. Firstly, the operation principle of the ion trap mass spectrometer will be explained. As shown in FIGS. 2(a) and 2(b), the ion trap mass spectrometer is composed of an annular ring electrode and two end cap electrodes arranged respectively in the opposite direction so as to hold it. Hereinafter, the ring electrode and two end cap electrodes are referred to as an ion trap electrode as a general term. A DC voltage U and an RF drive voltage V_{RF}cosΩt are applied between the ring electrode and the two end cap electrodes and a quadrupole electric field is formed in the inter-electrode space. The stability of the orbit of ions trapped in the electric field is decided by the size of the spectrometer (internal radius of the ring electrode r₀), the DC voltage U applied to the electrode, the amplitude V of the RF voltage, the angular frequency Ω thereof, and further the values a and q given by the ion mass-to-charge ratio m/Z (Formula (1)).

$$a = \frac{8 eU}{{r}_{0}^{2} {Ω}^{2}} \cdot \frac{Z}{m} , q = \frac{4 e {V}_{RF}}{{r}_{0}^{2} {Ω}^{2}} \cdot \frac{Z}{m} \qquad ( 1 )$$

where r₀ indicates an internal radius of the ring electrode, Z an ionic charge number, m mass, and e a quantum of electricity. FIG. 3 is a stability diagram showing the range of a and q for giving a stable orbit in the space between the ion trap electrodes. The region enclosed by a solid line is a stability region of positive ions and the region enclosed by a dashed line is a stability region of negative ions. When the mass-to-charge ratio m/Z is different, ions are equivalent to the different point (a,q) on the plane a-q shown in FIG. 3. When there is the point (a,q) in the respective stability regions of both positive and negative ions, both ions stably vibrate at a different frequency according to the mass-to-charge ratio m/Z and are trapped between the ion trap electrodes. The stability regions of positive ions and negative ions are in a relation of mirror symmetry to the axis a=0. The stability region (range of the value q) on the line a=0 is the same for both positive and negative ions, so that ions within this range are trapped between the ion trap electrodes regardless of the polarity (positive or negative) of the ion charge.

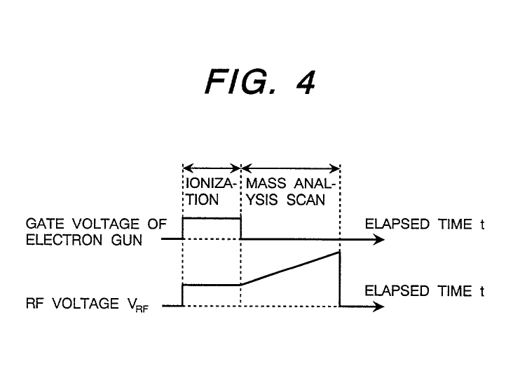

Next, the running method of the ion trap mass spectrometer of an internal ionization type for executing ionization and mass analysis in the space between the ion trap electrodes will be described. Generally, only the RF drive voltage V_{RF}cosΩt (RF drive voltage) is applied to the ring electrode and equivalent ions on the line a=0 in the stability region vibrate stably in the inter-electrode space and are trapped. In this case, the point (0,q) of ions in the stability region shown in FIG. 3 is different depending on the mass-to-charge ratio m/Z and ions are arranged between q=0 and q=0.908 on the axis a in the order from the larger mass-to-charge ratio to the smaller one from Formula (1) and vibrate at a different frequency according to the mass-to-charge ratio m/Z. The ion trap mass spectrometer superimposes a supplementary AC field at a certain specific frequency in the space between the ion trap electrodes using the point, thus ion species vibrating at the same frequency as that of the supplementary AC field are resonant, ejected from between the ion trap electrodes, and mass-separated. Furthermore, for ions in the specimen gas, the mass of ions to be mass-separated is sequentially scanned (mass analysis scan) and a mass distribution diagram (mass spectrum) of all specimen gas is obtained. The sequence of the process of mass analysis when the ion trap mass spectrometer of an internal ionization type lets specimen gas molecules flow between the ion trap electrodes in a neutral state and then as shown in FIGS. 2(a) and 2(b), adopts electron impact ionization (EI) for ionizing specimen gas molecules by letting specimen gas molecules collide with thermions emitted from the electron gun installed on the side of the end cap electrode on one side in the ion trap is shown in FIG. 4. When a positive voltage is applied to the gate electrode of the electron gun, an electron beam injects in the ion trap electrode and neutral specimen gas between the ion trap electrodes is ionized. This period is referred to as an ionization period. In this case, the amplitude value of the RF drive voltage is set at a certain low fixed value. Thereafter, during the mass analysis scan period, the mass number of all ionized specimen gas is analyzed. During this period, on the basis of the relational formula (Formula (1)) that when the value q of ions subjected to resonance ejection and mass separation is fixed, the ion mass number M is proportional to the RF drive voltage amplitude value V_{RF}, the RF drive voltage amplitude value V_{RF} is scanned, thereby the mass number of mass-separated ions is scanned and the whole specimen gas is mass-separated in succession.

The ion number to be trapped in the space between the ion trap electrodes is limited practically. The reason is that as the ion number to be trapped increases, the effect of the space charge becomes great and the analytical capacity is reduced. Particularly, in the case of the internal ionization type of ionization by EI in the space between the ion trap electrodes as mentioned above, most generated ions are positive and the generation amount of negative ions is less than that of positive ions by 3 digits. Namely, in the ion trap that the ion number to be trapped is limited, positive ions are trapped mainly and negative ions are hardly trapped.

Next, the first embodiment will be explained.

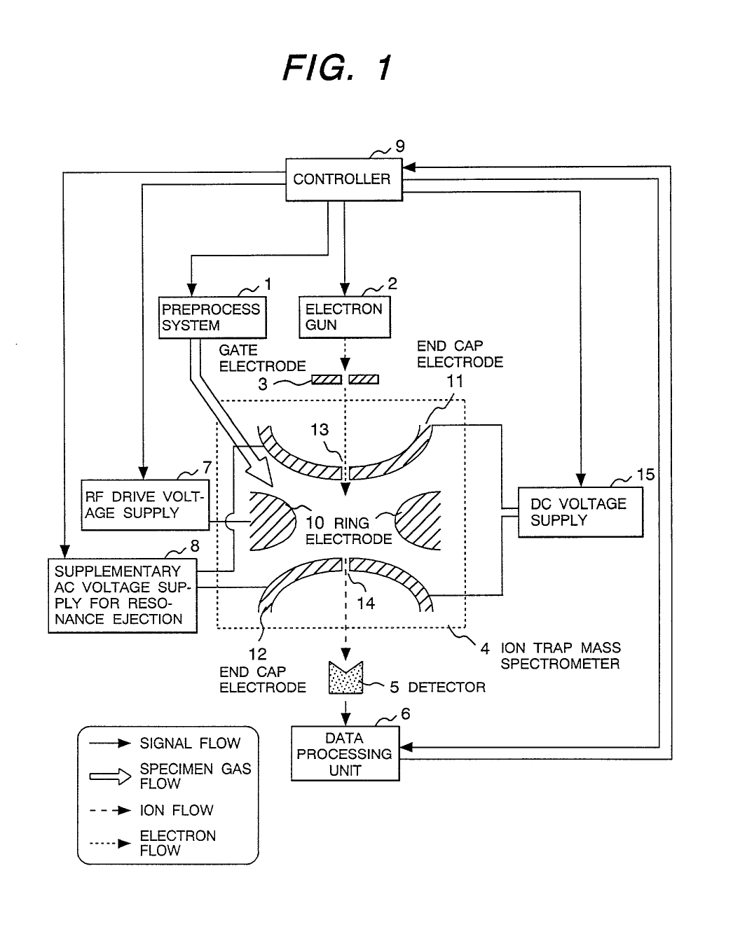

FIG. 1 is a schematic view of the whole ion trap mass spectrometer of the first embodiment of the present invention. Mixed specimen gas to be mass-analyzed is ingredient-separated via the preprocess 1 such as gas chromatography and injected into an ion trap mass spectrograph 4. The ion trap mass spectrograph 4 is composed of an annular ring electrode 10 and two end cap electrodes 11 and 12 arranged opposite to each other so as to hold it and in the inter-electrode space composed of the electrodes, a quadrupole electric field is generated by the RF drive voltage V_{RF}cosΩt supplied to the ring electrode 10 from an RF drive voltage supply 7. Thermions emitted from an electron gun 2 pass through a gate electrode 3 only when a positive voltage is applied to the gate electrode 3, pass through an aperture for specimen injection 13 of the end cap electrode 11, and is injected between the ring electrode 10 and the end cap electrodes 11 and 12 (inter-electrode space). The neutral specimen gas injected from the preprocess 1 is ionized (electron impact ionization (EI)) by an impact with thermions emitted from the electron gun 2 in the ion trap and trapped by the quadrupole electric field. In this case, generally, only the RF drive voltage V_{RF}cosΩt (RF drive voltage) is applied to the ring electrode and equivalent ions on the line a=0 in the stability region vibrate stably in the inter-electrode space and are trapped. In this case, the point (0,q) of ions in the stability region shown in FIG. 3 is different depending on the mass-to-charge ratio m/Z and ion are arranged between q=0 and q=0.908 on the axis a in the order from the larger mass-to-charge ratio to the smaller one from Formula (1) and vibrate at a different frequency according to the mass-to-charge ratio m/Z. Thereafter, ions having a different mass-to-charge ratio are sequentially mass-separated (mass analysis scan).

There are two mass separation methods available. One of them, in the stability diagram shown in FIG. 3, is a method for adjusting the RF drive voltage V_{RF}cosΩt so as to set the point (a,q) of specific ion species outside the stability region ((a, q)=(0,0.908)), making the orbit of specific species unstable, executing mass separation, and ejecting from the inter-electrode space. The second one is a method (resonance ejection) for resonance-amplifying and mass-separating specific ion species by a supplementary AC field generated by applying a supplementary AC voltage for resonance ejection having a frequency lower than the RF drive voltage frequency between the end cap electrodes 11 and 12 from a supplementary AC voltage supply for resonance ejection 8.

FIG. 1 shows a whole diagram when the latter mass separation method is adopted. When the former mass separation method is adopted, the supplementary AC voltage supply for resonance ejection 8 is not necessary. Even if either of the mass separation methods is used, when the amplitude VRF of the RF drive voltage or the frequency Ω/2π is scanned, the mass number of mass separation ions is scanned and the whole specimen gas is mass-separated in succession. By the aforementioned methods, mass-analyzed ions are sequentially ejected from the inter-electrode space according to the mass-to-charge ratio. Ions passing through an aperture for ion ejection 14 of the end cap electrode 12 are detected by a detector 5 and processed by a data processing unit 6. The whole of this series of the mass analysis process including ionization of specimen gas, transfer and injection of a specimen gas ion beam into the ion trap mass spectrometer, adjustment of the RF drive voltage amplitude at the time of injection of specimen gas ions, sweeping of the RF drive voltage amplitude (sweeping of the mass-to-charge ratio of ions to be mass-analyzed), adjustment and detection of the amplitude of the supplementary AC voltage, the kind of supplementary AC voltage, and timing, and data processing is controlled by a controller 9.

In the ion trap mass spectrometer of a type of ionization (internal ionization type) in the space between the ion trap electrodes (the ring electrode 10 and the end cap electrodes 11 and 12) as mentioned above, positive ions are generated in an overwhelmingly large amount and negative ions generated in an extremely small amount are little trapped and are not an analytical object.

In this embodiment of the present invention, positive ions are ejected from the space between the ion trap electrodes at the same time with ionization during the ionization period, so that generated negative ions are trapped in priority and mass analysis of negative ions is made possible.

The method of this embodiment for ejecting positive ions from the space between the ion trap electrodes during the ionization period will be explained hereunder by referring to FIGS. 1 to 3 and FIGS. 5 to 7.

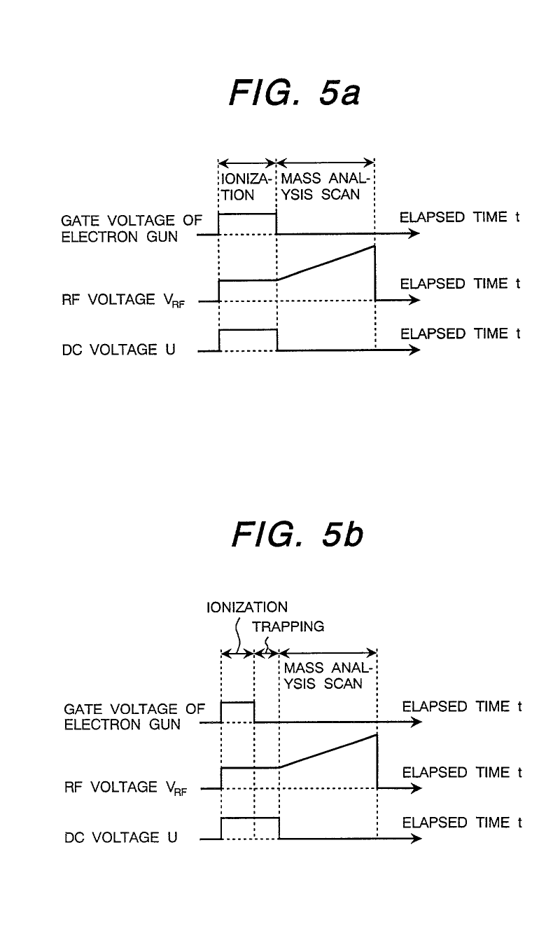

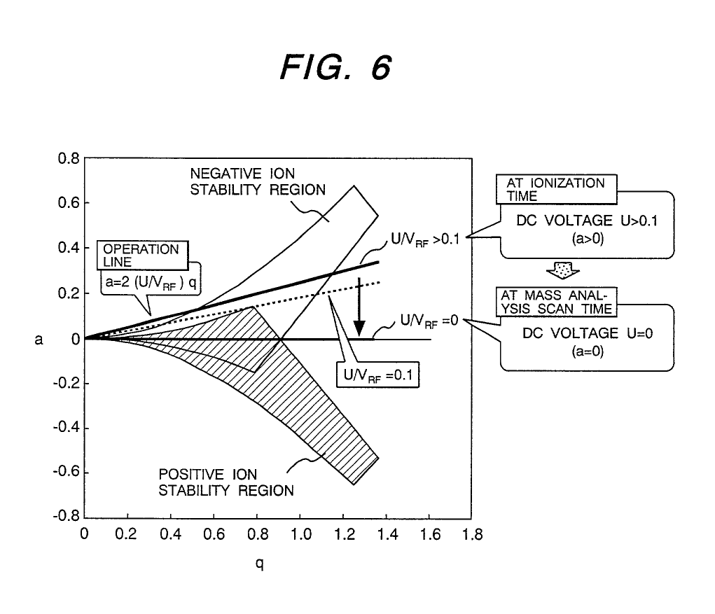

FIG. 5 shows the sequence of the process of mass analysis. As shown in FIG. 5(a), in this embodiment, during the ionization period, that is, during the period that thermions emitted from the electron gun 2 are injected between the ion trap electrodes and ionize specimen gas by EI, in addition to the RF drive voltage, as shown in FIGS. 1 and 2(a), a positive DC voltage U (>0) of the same magnitude is applied between the two end cap electrodes 11 and 12 from a DC voltage supply 15. When the DC voltage U and RF drive voltage amplitude V_{RF} are decided from Formula (1), the point (a,q) of all ion species in the stability diagram shown in FIG. 3 is put on the operation line of a=2q(U/V_{RF}). Here, as shown in FIG. 6, the ratio (U/V_{RF}) of DC voltage to RF drive voltage amplitude V_{RF}, is set so as to be larger than _{0.1.} In this case, the operation line is not overlaid with the stability region of positive ions, so that positive ions cannot exist stably in the ion trap, accordingly negative ions are trapped in the ion trap in priority in correspondence to it. At the time of mass analysis scan after ionization, the DC voltage U is set to 0, so that the operation line is set to a=0 in the stability region and the ordinary mass analysis scan method can be used. Next, the effect of this embodiment will be indicated using the results actually obtained by numerical analysis.

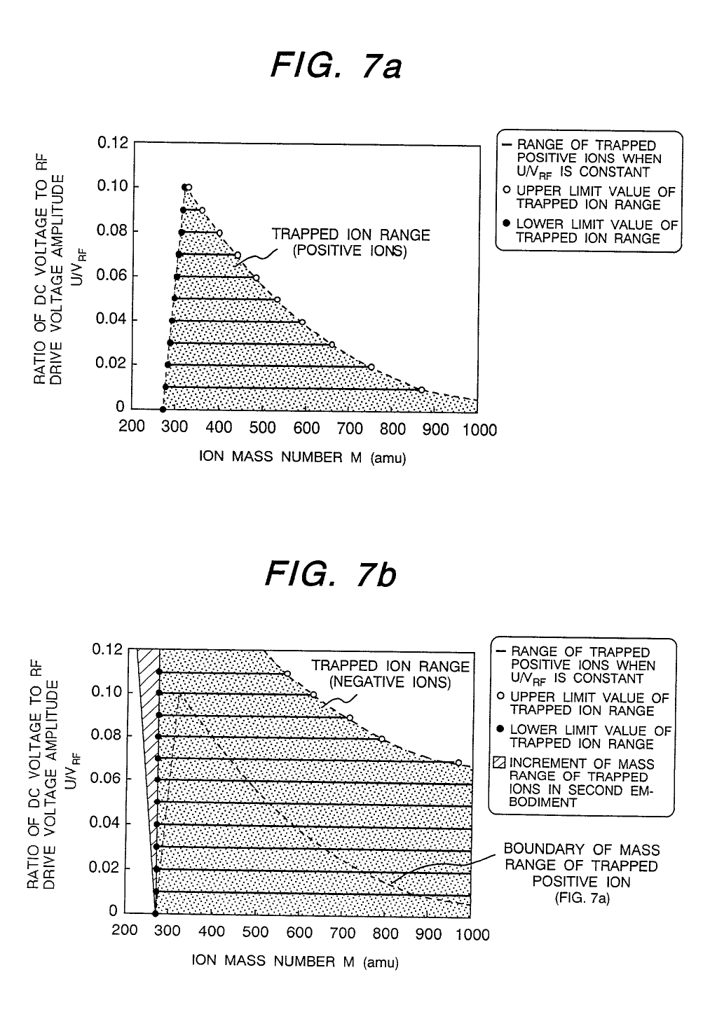

When the ratio (U/V_{RF}) of DC voltage U to RF drive voltage amplitude V_{RF} is changed within the range from 0 to 0.12, the ion orbit in the ion trap is analyzed and the mass number range of ions stably trapped is obtained. The results of positive ions and negative ions are shown in FIGS. 7a and 7b respectively. The mass range of trapped positive ions decreases as U/V_{RF} increases and when U/V_{RF}>0.1, positive ions are all made unstable and cannot be trapped in the ion trap. On the other hand, although the mass range of trapped negative ions also decreases as U/V_{RF} increases, even in the region of U/V_{RF}>0.1, it is found that negative ions in the wide mass range are stably trapped. Therefore, according to this embodiment, positive ions can be all ejected and negative ions are trapped and collected in priority, so that negative ion analysis by the ion trap mass spectrometer of an internal ionization type is made possible.

In this case, as shown in FIG. 2(b), the DC voltage U to be applied may be applied to the ring electrode 10. However, in this case, when a negative DC voltage (<0) is applied, the same effect as that shown in FIG. 2 is obtained. Furthermore, with respect to the period of application of a DC voltage, as shown in FIG. 5(b), when mass analysis scan is to be executed after a certain interval (trap period) after the ionization period, the DC voltage may be applied until the trap period. In this case, the certainty of positive ion ejection is enhanced.

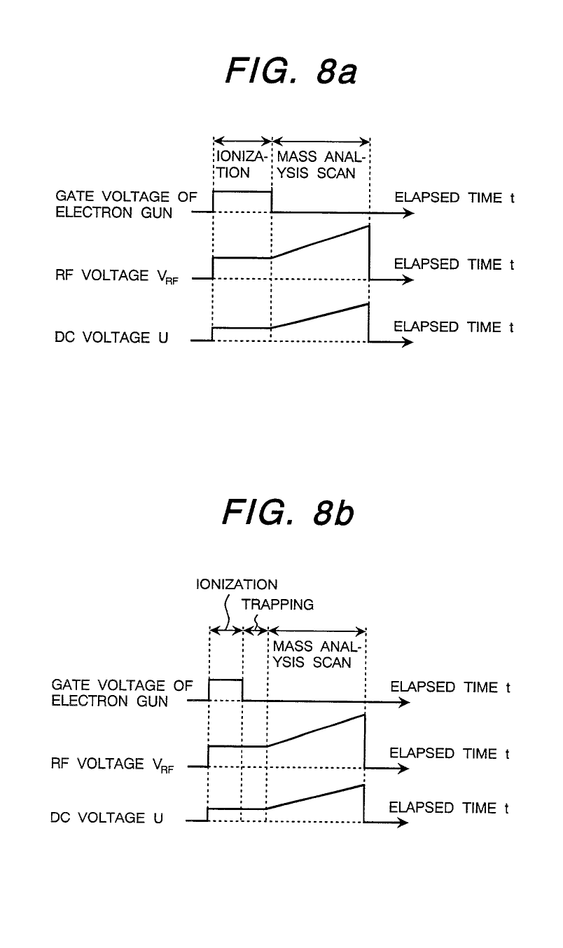

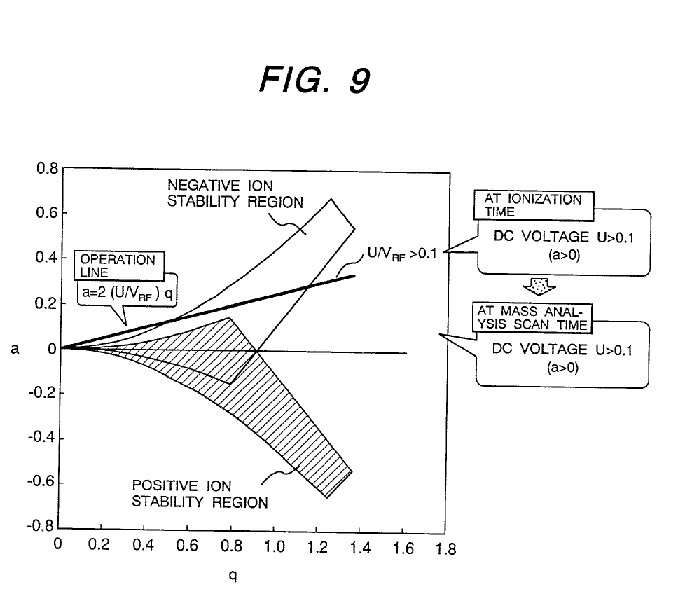

Next, the second embodiment of the present invention will be explained by referring to FIGS. 8 to 10. As shown in FIGS, 8(a) and 8(b), during the ionization period (FIG. 8(a)) or from the ionization period to the trap period (FIG. 8(b)), a fixed DC voltage is applied between the ion trap electrodes and then the DC voltage is also applied during the mass analysis scan period. However, the DC voltage U to be applied during the mass analysis scan period is scanned in the same way as with the RF drive voltage amplitude V_{RF} so as to make the ratio (U/V_{RF}) to RF drive voltage amplitude V_{RF} constant. In the first embodiment, the DC voltage is not applied (U=0) during mass analysis scan, so that the operation line is changed to a=0 and the mass range of trapped ions having a large q value, that is, ions on the small mass number side is contracted. In this embodiment, as shown in FIG. 9, the inclination (U/V_{RF}) of the operation line is fixed and the operation line is not changed to a=₀, so that the mass analysis of specimen gas is made possible with the mass range of trapped negative ions kept unchanged. Next, the effect of this embodiment will be indicated using the results ascertained by numerical analysis.

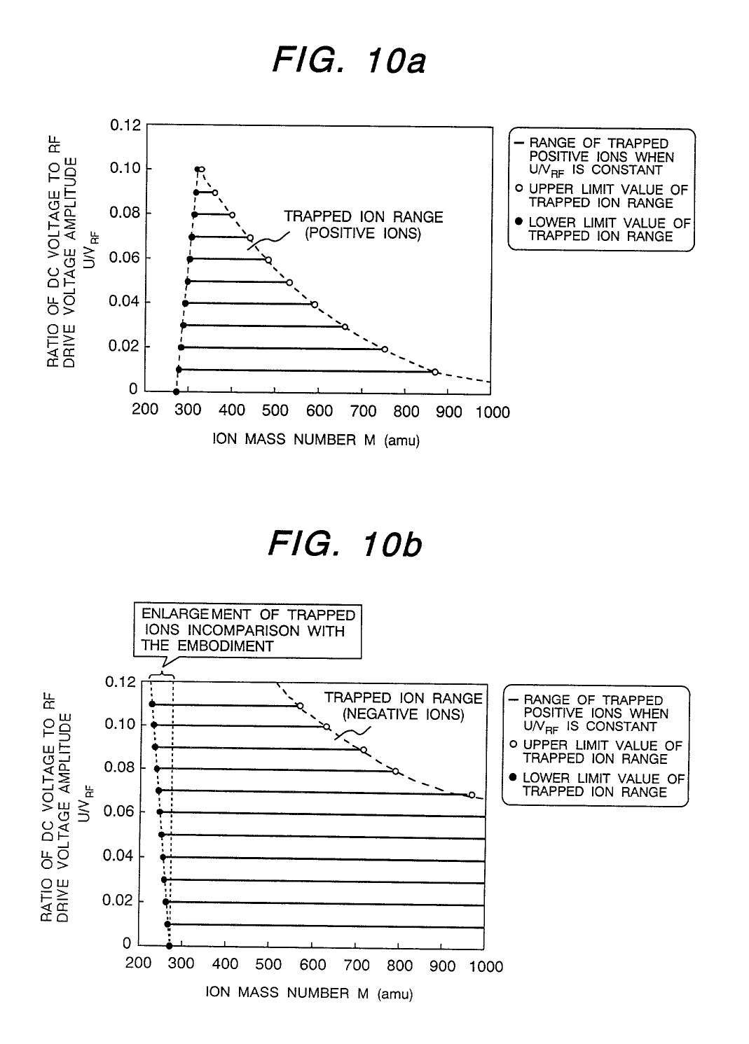

When the ratio (U/V_{RF}) of DC voltage to RF drive voltage amplitude V_{RF} is changed within the range from 0 to 0.12, the ion orbit in the ion trap is analyzed and the mass number range of ions stably trapped is obtained. The results of positive ions and negative ions are shown in FIGS. 10a and 10b respectively. The mass range of trapped positive ions is the same as the result obtained in the first embodiment. However, with respect to negative ions, it is found that the mass range of trapped negative ions is expanded on the small mass number side compared with the result obtained in the first embodiment. Therefore, according to this embodiment, positive ions can be all ejected and furthermore, negative ions in the wide mass number range are trapped and collected in priority without contracting the mass range of trapped ions on the small mass number side, so that negative ion analysis by the ion trap mass spectrometer of an internal ionization type is made possible.

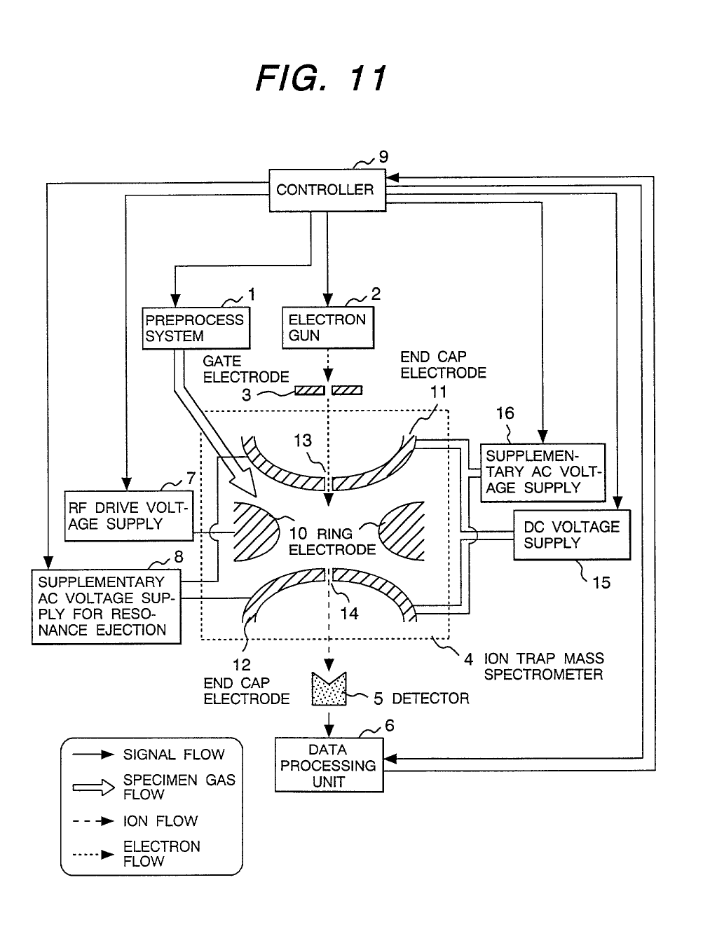

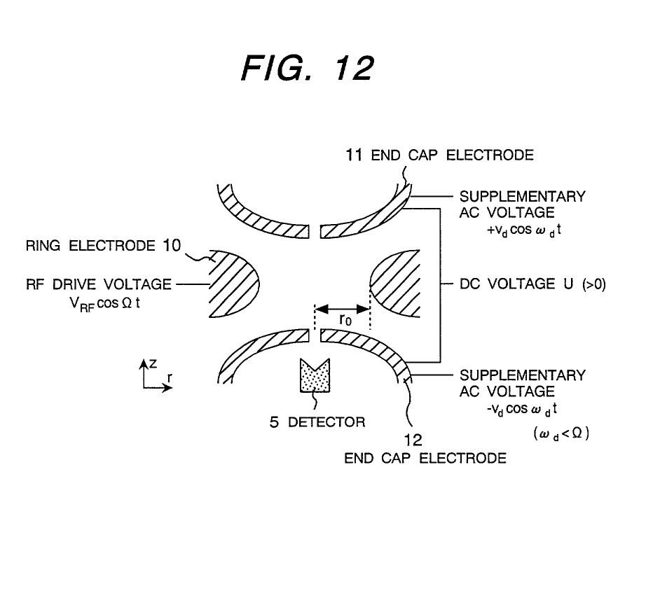

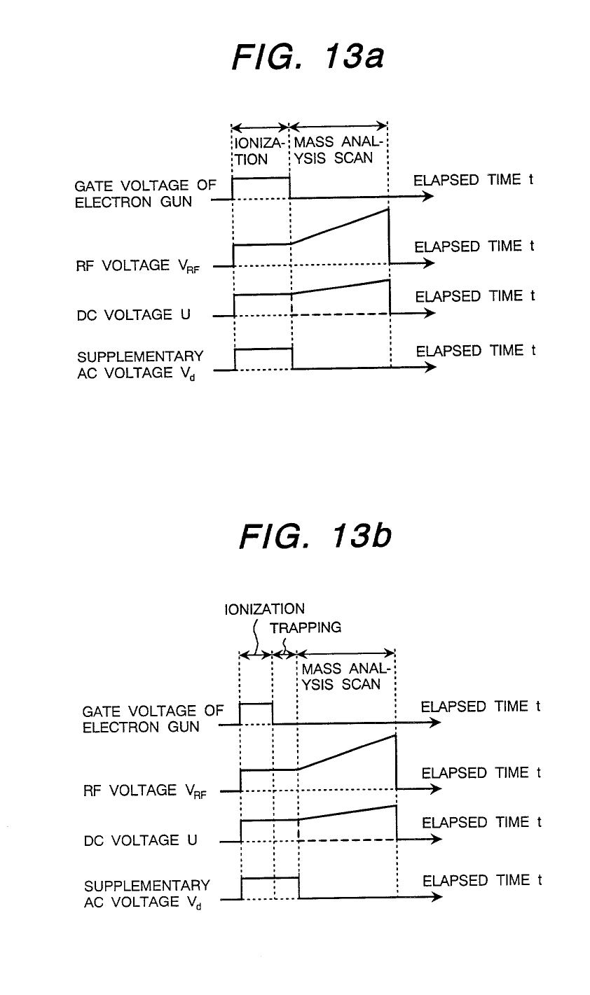

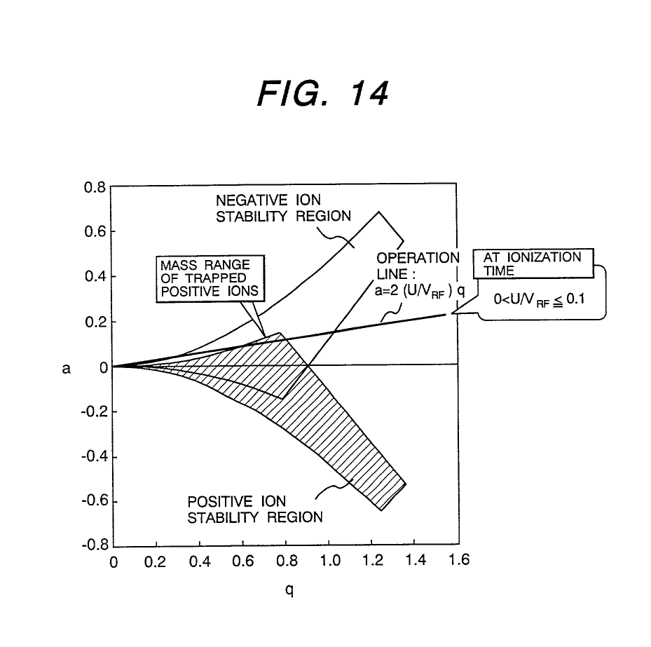

The third embodiment of the present invention will be explained hereunder by referring to FIGS. 11 to 15. FIG. 11 is a schematic view of the whole ion trap mass spectrometer of this embodiment. Here, particularly when the ratio (U/V_{RF}) of DC voltage U to RF drive voltage amplitude V_{RF} is changed to 0.1 or less (0<(U/V_{RF})≦0.1), as shown in FIG. 14, a region where the operation line is overlaid with the stability region of positive ions is generated. In order to resolution-eject positive ions equivalent to this region, the supplementary AC field is additionally superimposed. This embodiment is characterized in that as shown in FIGS. 11, 12, 13(a), and 13(b), during the ionization period (FIG. 13(a)) or from the ionization period to the trap period (FIG. 13(b)), in addition to the RF drive voltage to be applied between the ion trap electrodes, a DC voltage (U>0) of the same magnitude is applied to each of the end cap electrodes and furthermore, a supplementary AC voltage (±v_{d}cosω_{d}t) with half-phase shifted to each of the end cap electrodes from the supplementary AC voltage supply 16. In this case, the supplementary AC field generated between the ion trap electrodes is a dipole supplementary field. In this case, the frequency ω_{d}2π of the supplementary AC voltage (±v_{d}cosω_{d}t) coincides with the natural number of vibration ω_{z}2π in the ion trap axial direction (direction z) when typical positive ions equivalent to the region where the operation line is overlaid with the stability region of positive ions vibrate in the ion trap. The natural number of vibration of positive ions is obtained by Formula (2) from the β_{z} value indicated in the stability region of positive ions shown in FIG. 3.

ω_{z}/2π=β_{z}×Ω/4π (2)

In this case, as shown in FIG. 3, in the region where the operation line is overlaid with the stability region of positive ions, the natural number of vibration (or β_{z} value) of positive ions and the natural number of vibration (or β_{z} value) of negative ions are different from each other, so that the supplementary AC field at the frequency for resonance of positive ions will not affect greatly the mass range of trapped negative ions.

Next, the effect of this embodiment will be indicated using the results actually obtained by numerical analysis.

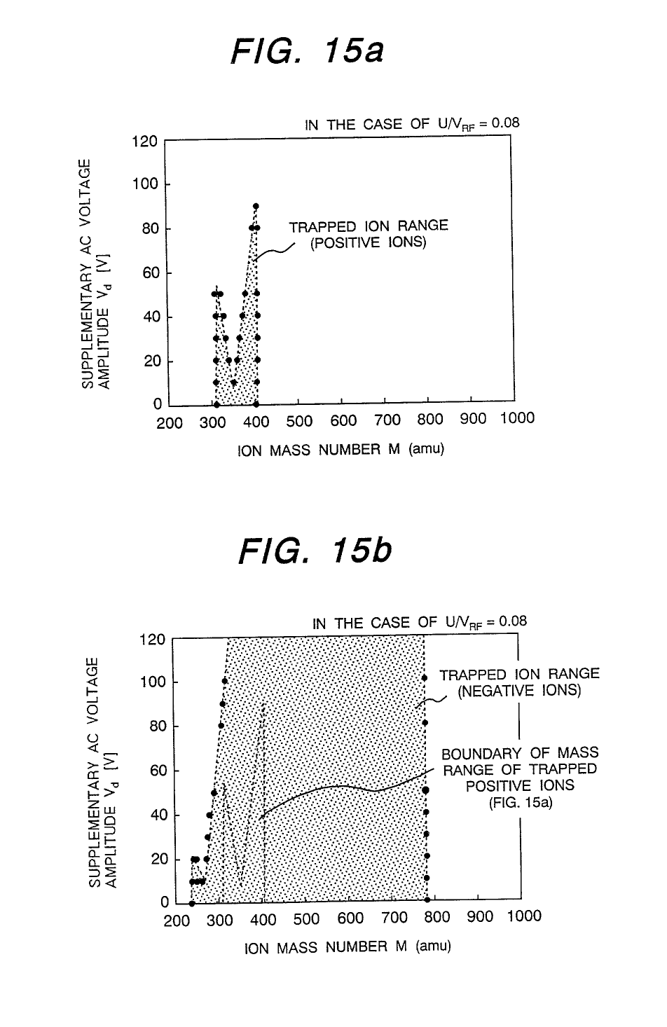

When the ratio (U/V_{RF}) of DC voltage to RF drive voltage amplitude V_{RF} is fixed to 0.08, and the supplementary AC voltage (±v_{d}cosω_{d}t) with half-phase shifted when β_{z}=0.726 is set is applied to each of the end cap electrodes (when positive ions equivalent to β_{z}=0.726 are assumed as a target of resonance ejection), and the supplementary AC voltage amplitude v_{d} is changed, the ion orbit in the ion trap is analyzed and the mass number range of ions stably trapped is obtained. However, the DC voltage U to be applied to each of the end cap electrodes is scanned so as to make U/V_{RF} constant as shown by a solid line in FIG. 13 during the mass analysis scan period. The results of positive ions and negative ions are shown in FIGS. 15(a) and 15(b) respectively. When no supplementary AC voltage is applied (vd=O), it is found that the mass range of trapped positive ions (313 to 408 amu) decreases as the supplementary AC voltage amplitude v_{d} increases and when the supplementary AC voltage amplitude v_{d} is more than 90 V, positive ions are ejected very highly efficiently.

On the other hand, it is found that although the mass range of trapped negative ions slightly decreases as the supplementary AC voltage amplitude v_{d} increases, as compared with the first and second embodiments, the mass range of trapped ions is greatly expanded on the larger mass number side. The reason is that as shown in FIG. 14, when U/V_{RF} is smaller, the region where the operation line is overlaid with the stability region of negative ions increases on the larger mass number side (region having a smaller q value). Therefore, according to this embodiment, positive ions can be all ejected, and furthermore, the mass range of trapped negative ions can be expanded on the larger mass number side, and negative ions within the wide mass number range can be trapped and collected in priority, so that negative ion analysis by the ion trap mass spectrometer of an internal ionization type is made possible. In this case, the DC voltage U to be applied to each of the end cap electrodes may be set to 0 as indicated by a dashed line shown in FIG. 13 during the mass analysis scan. The supplementary AC voltage to eject positive ions may be supplied by the supplementary AC voltage supply for resonance ejection 8 without installing the supplementary AC voltage supply 16.

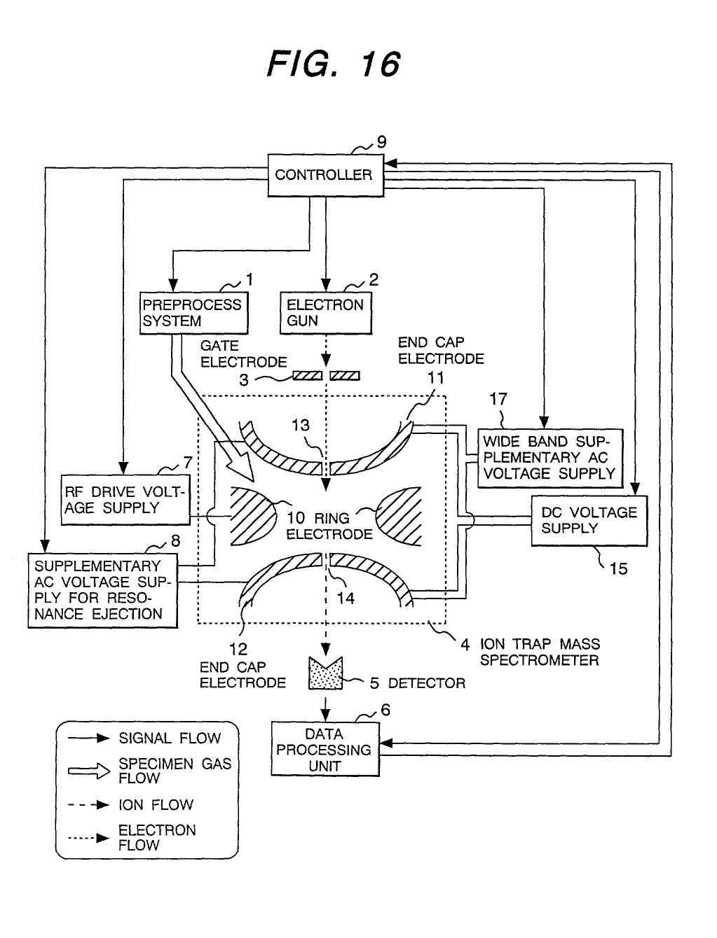

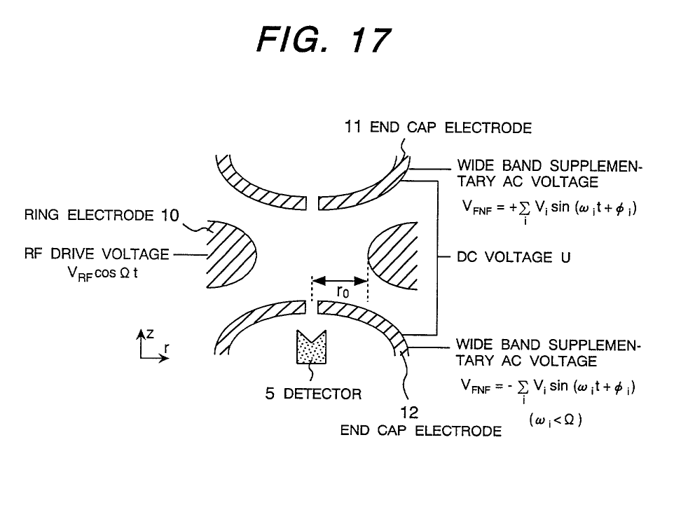

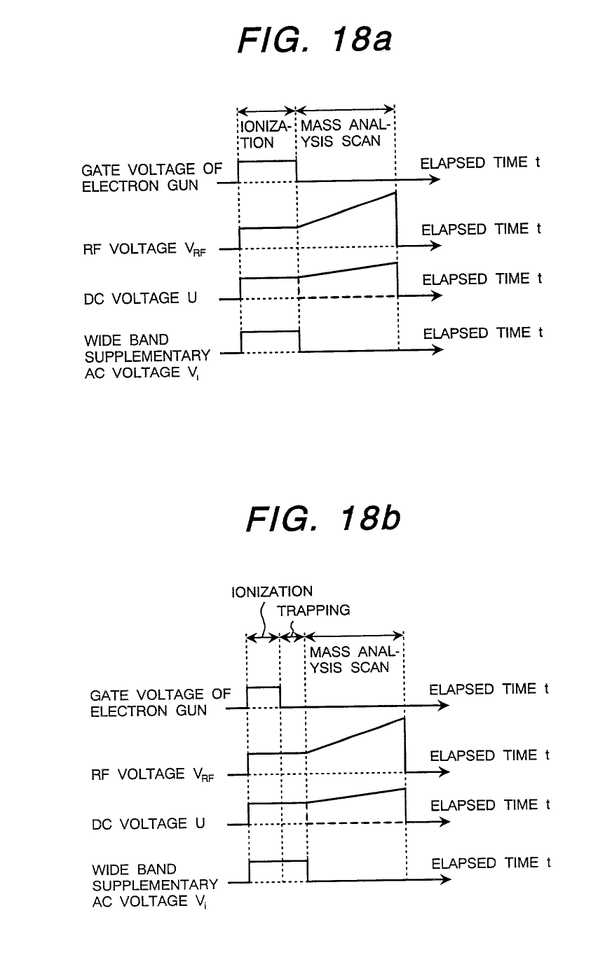

The fourth embodiment of the present invention will be explained hereunder by referring to FIGS. 16 to 19. FIG. 16 is a schematic view of the whole ion trap mass spectrometer of this embodiment. Here, particularly when the ratio (U/V_{RF}) of DC voltage U to RF drive voltage amplitude V_{RF} is changed to 0.1 or less (0<(U/V_{RF})≦0.1), as shown in FIG. 14, in order to resonance-eject positive ions equivalent to the region where the operation line is overlaid with the stability region of positive ions, the supplementary AC field is additionally superimposed. This embodiment is characterized in that as shown in FIGS. 16, 17, 18(a), and 18(b), during the ionization period (FIG. 18(a)) or from the ionization period to the trap period (FIG. 18(b)), in addition to the RF drive voltage to be applied between the ion trap electrodes, a DC voltage (U>0) of the same magnitude is applied to each of the end cap electrodes and furthermore, a wide band supplementary AC voltage (the following formula) with half-phase shifted having a different frequency ingredient within a certain frequency range to each of the end cap electrodes from the wide band supplementary AC voltage supply 17.

Wide band supplementary AC voltage=

$$Wide band supplementary AC voltage = \pm {{\sum }^{n}}_{i} {v}_{i} sin ( {ω}_{i} t + {φ}_{i} )$$

In this case, it is desirable that the range of the frequency ingredient frequency ωᵢ/2π of the wide band supplementary AC voltage coincides with the range of the natural number of vibration frequency ωᵢ/2π in the ion trap axial direction (direction z) when positive ions within the range of positive ions which are equivalent to the region where the operation line is overlaid with the stability region of positive ions and stably trapped in the ion trap vibrate in the ion trap. Next, the effect of this embodiment will be indicated using the results actually obtained by numerical analysis.

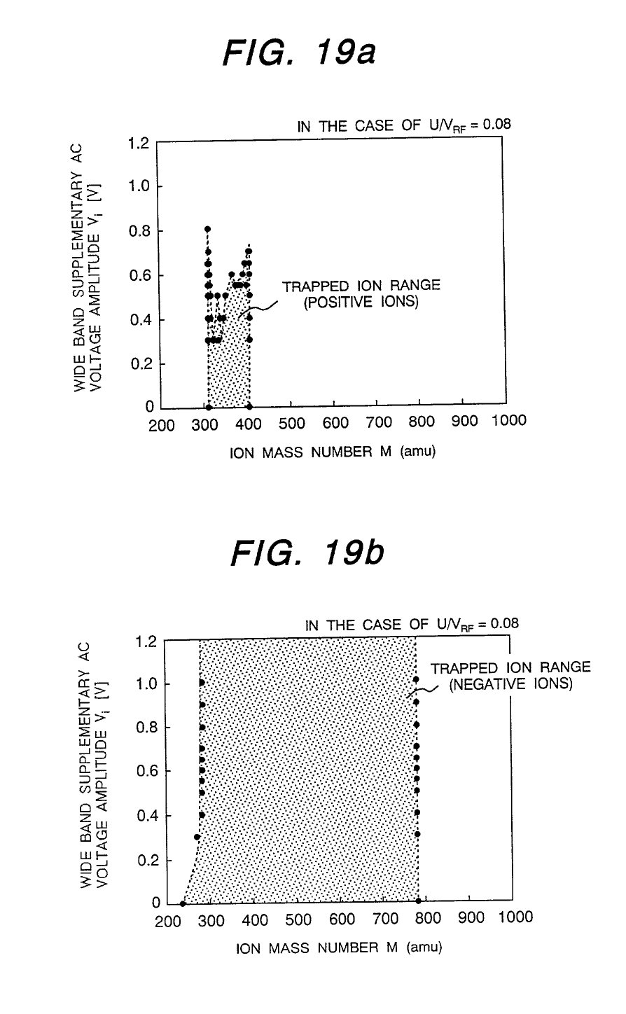

When the ratio (U/V_{RF}) of DC voltage to RF drive voltage amplitude V_{RF} is fixed to 0.08, and the frequency range when β_{z}=0.597 to 0.937 is set for ejection of positive ions is obtained from Formula (2) (ωᵢ/2π=Ω/4π), and the wide band supplementary AC voltage with half-phase shifted having a frequency ingredient at an interval of 1 kHz is applied to each of the end cap electrodes within the range, and the wide band supplementary AC voltage amplitude vi is changed, the mass range of stably trapped ions is obtained. However, the DC voltage U to be applied to each of the end cap electrodes is scanned so as to make U/V_{RF} constant as shown by a solid line in FIG. 18 during the mass analysis scan period. The results of positive ions and negative ions are shown in FIGS. 19(a) and 19(b) respectively. When no supplementary AC voltage is applied (vᵢ=0), it is found that the mass range of trapped positive ions (313 to 408 amu) decreases as the supplementary AC voltage amplitude vi increases and when the supplementary AC voltage amplitude vi is more than 0.8 V, positive ions are ejected very highly efficiently. On the other hand, it is found that although the mass range of trapped negative ions slightly decreases as the supplementary AC voltage amplitude vi increases up to about 0.3 V, when vᵢ is more 0.3 V, the mass range of trapped negative ions changes little and is kept almost constant. As compared with the first to third embodiments, it is found that the effect on the mass range of trapped negative ions is least. The reason is that the supplementary AC field is a supplementary AC field having a wide band frequency ingredient, so that the voltage of each frequency ingredient can be reduced and the effect is little. Therefore, according to this embodiment, positive ions can be all ejected, and furthermore, the mass range of trapped negative ions can be expanded on the larger mass number side, and negative ions within the wide mass number range can be trapped and collected in priority, so that negative ion analysis by the ion trap mass spectrometer of an internal ionization type is made possible. In this case, the DC voltage U to be applied to each of the end cap electrodes may be set to 0 as indicated by a dashed line shown in FIG. 18. The supplementary AC voltage for resonance ejection to be applied at the time of mass analysis scan can be supplied as a supplementary AC voltage of a single frequency ingredient by the supplementary AC voltage supply 17 and the supplementary AC voltage supply for resonance ejection 8 can be omitted.

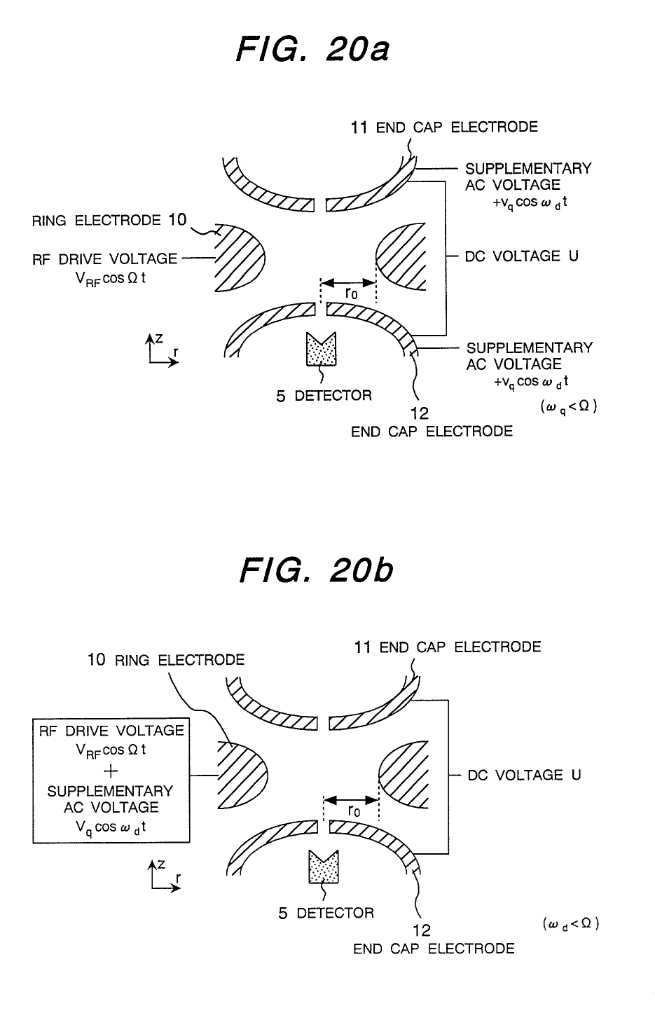

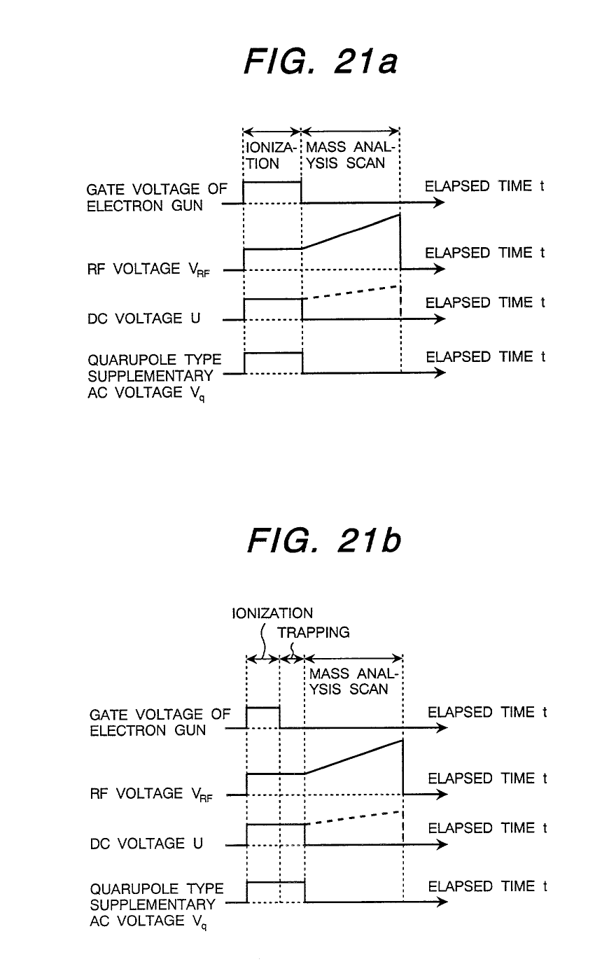

The fifth embodiment of the present invention will be explained hereunder by referring to FIGS. 16 and 20 to 22. Here, particularly when the ratio (U/V_{RF}) of DC voltage U to RF drive voltage amplitude V_{RF} is changed to 0.1 or less (0<(U/V_{RF})≦0.1), as shown in FIG. 14, in order to resonance-eject positive ions equivalent to the region where the operation line is overlaid with the stability region of positive ions, the supplementary AC field is additionally superimposed. This embodiment is characterized in that as shown in FIGS. 16, 20(a), 21(a), and 21(b), during the ionization period (FIG. 21(a)) or from the ionization period to the trap period (FIG. 21(b)), in addition to the RF drive voltage to be applied between the ion trap electrodes, a DC voltage (U>0) of the same magnitude is applied to each of the end cap electrodes and furthermore, a supplementary AC voltage (v_{q}cosω_{q}t) in the same phase is applied to the end cap electrodes respectively from the supplementary AC voltage supply 16. In this case, the supplementary AC field generated between the ion trap electrodes is a quadrupole type supplementary field. Even if the quadrupole type supplementary AC field is applied to the ring electrode as shown in FIG. 20(b) in the same as with the RF drive voltage, the same quadrupole type supplementary AC field as that shown in FIG. 20(a) is formed. In this case, the frequency ω_{q}/2π of the supplementary AC voltage (v_{d}cosωdt) coincides with any of the natural numbers of vibration ω_{z}/2π and ωᵣ/2π in the ion trap axial direction (direction z) or the radial direction (direction r) when typical positive ions equivalent to the region where the operation line is overlaid with the stability region of positive ions vibrate in the ion trap. The natural numbers of vibration of positive ions in the directions r and z are obtained by Formula (3) from the βᵣ and β_{z} values indicated in the stability region of positive ions shown in FIG. 3.

ω_{r,z}/2π=β_{r,z}×Ω/4π (3)

Next, the effect of this embodiment will be indicated using the results actually obtained by numerical analysis.

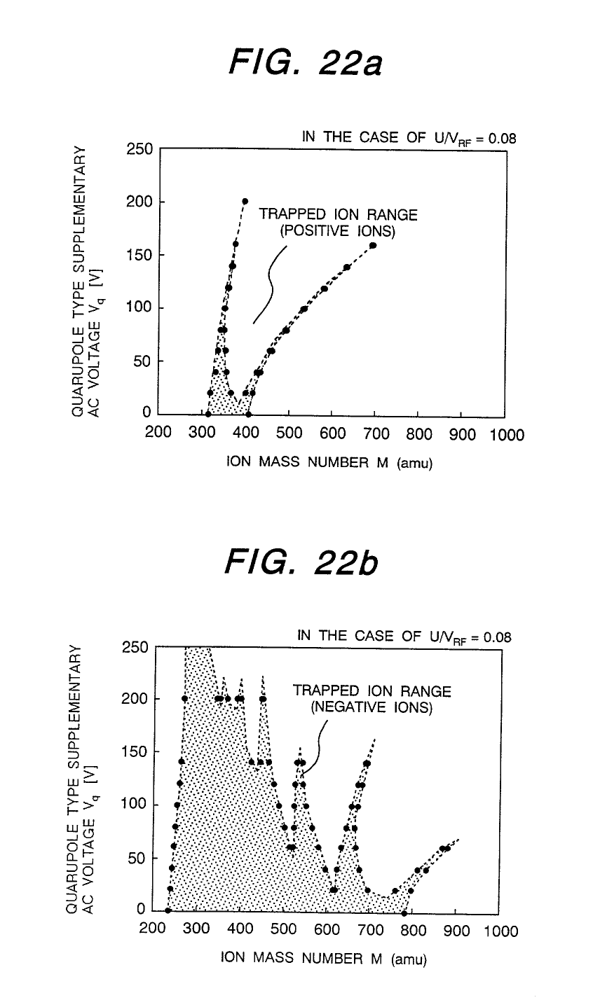

When the ratio (U/V_{RF}) of DC voltage to RF drive voltage amplitude V_{RF} is fixed to 0.08, and the quarupole type supplementary AC voltage (v_{q}cosω_{q}t) when βᵣ=0.0652 is set is applied to each of the end cap electrodes (set as a target of resonance ejection of positive ions equivalent to εᵣ=0.0652), and the quarupole type supplementary AC voltage amplitude v_{d} is changed, the ion orbit in the ion trap is analyzed and the mass number range of ions stably trapped is obtained. However, the DC voltage U to be applied to each of the end cap electrodes is scanned so as to make U/V_{RF} constant as shown by a solid line in FIG. 21 during the mass analysis scan period. The results of positive ions and negative ions are shown in FIGS. 22(a) and 22(b) respectively. When no quadrupole type supplementary AC voltage is applied (v_{q}=0), it is found that the mass range of trapped positive ions (313 to 408 amu) decreases as the quadrupole type supplementary AC voltage amplitude v_{q} increases and when the quadrupole supplementary AC voltage amplitude v_{q} is more than 200 V, positive ions are ejected very highly efficiently. On the other hand, it is found that although the mass range of trapped negative ions decreases as the supplementary AC voltage amplitude v_{d} increases, even when the quadrupole supplementary AC voltage amplitude v_{q} is more than 200 V, some amount of mass range exists. However, as compared with the previous results of the embodiment, the mass range of trapped negative ions is narrower. The reason is that since the supplementary electric field is of a quarupole type, the RF trap electric field generated in the ion trap electrode is easily affected. Particularly, with respect of negative ions on the scanning line having an inclination of U/V_{RF}=0.08, ions equivalent to βᵣ=0.0652 are ions on the higher mass number side, so that the mass range on the higher mass number side is narrower. However, when the mass range of trapped ions necessary for mass analysis is not so wider, the quadrupole supplementary AC voltage can be easily applied, so that according to this embodiment, positive ions can be all ejected easily and furthermore, negative ions can be trapped in priority. Further, there is an advantage that since the mass range of negative ions to be trapped is narrow, the trap amount for ion species can be increased in correspondence to it. Also in this case, the DC voltage U to be applied to each of the end cap electrodes may be set to 0 as indicated by a dashed line shown in FIG. 21 during the mass analysis scan.

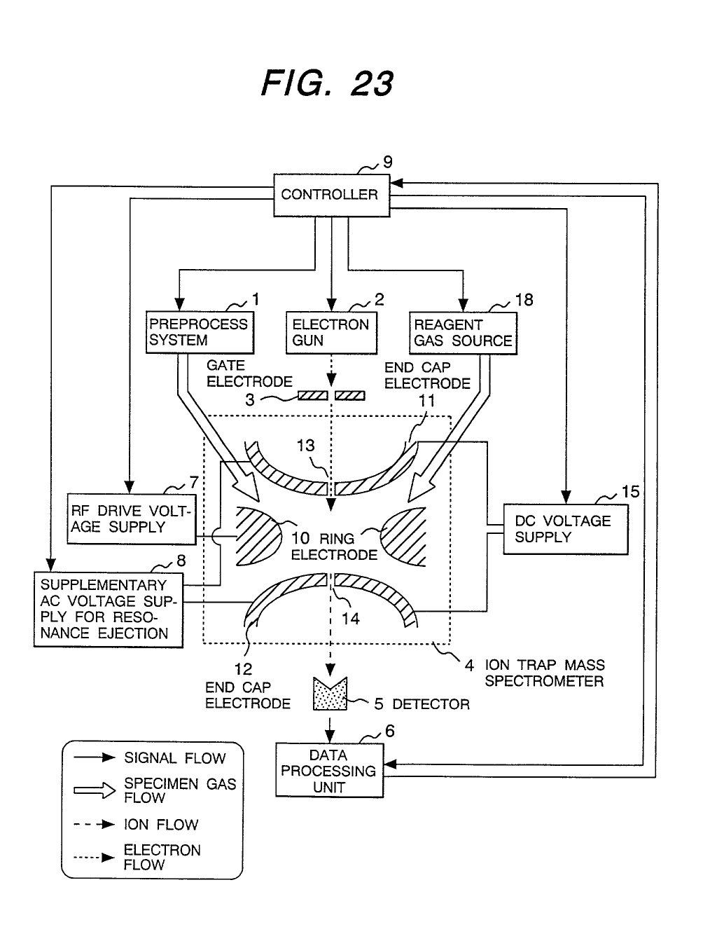

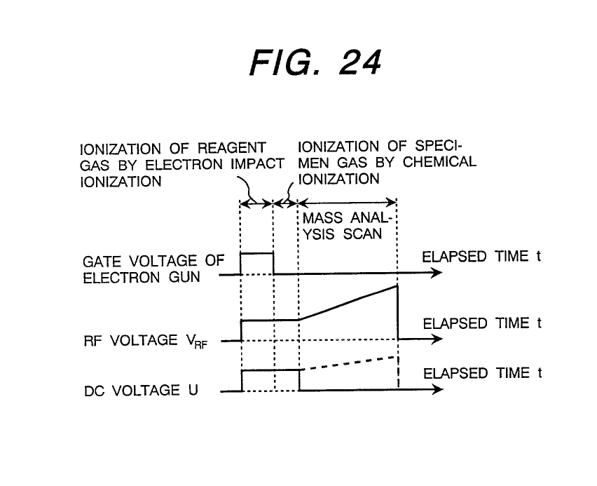

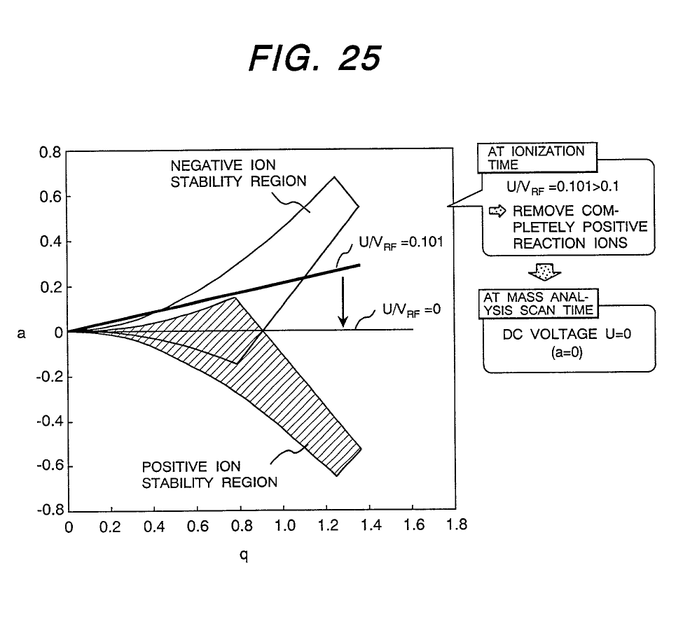

The sixth embodiment of the present invention will be explained hereunder by referring to FIGS. 23 to 26. FIG. 23 is a schematic view of the whole ion trap mass spectrometer of this embodiment. This embodiment uses an ion trap mass spectrometer of an internal ionization type for analyzing negative ions generated by so-called chemical ionization (CI) for ionizing specimen gas by reacting reagent gas flowing between the ion trap electrodes from a reagent gas source 18 with negative reagent ions generated by ionization (EI) by an electron impact in the space between the ion trap electrodes. In the aforementioned, when ions generated by CI are to be analyzed by the ion trap mass spectrometer of an internal ionization type, most reagent gas generated by EI is positive ions and only positive specimen gas ions are generated from reaction (chemical ionization) with positive reagent gas ions, so that only positive ions are analyzed. In order to generate negative ions by CI, in ionization of reagent gas, it is necessary to eject positive reagent gas ions generated in a large amount from the ion trap, trap negative reagent gas ions in priority, and react negative reagent gas ions with specimen gas. Therefore, this embodiment is characterized in that at least during the ionization period of reagent gas by EI, a DC voltage is applied to each of the end cap electrodes, thereby positive reagent gas ions generated in a large amount are ejected. As shown in FIG. 24, during the ionization period of reagent gas by EI and during the ionization period of specimen gas by CI, in addition to the RF drive voltage, as shown in FIG. 23, the DC voltage U (>0) of the same magnitude is applied between the end cap electrodes 11 and 12 from the DC voltage supply 15. Here, as shown in FIG. 25, the ratio (U/V_{RF}) of DC voltage to RF drive voltage amplitude VRF is set to more than 0.1. In this case, the operation line is not overlaid with the stability region of positive ions during the ionization period of reagent gas by EI, so that positive reagent gas ions are all made unstable and ejected outside the ion trap and only negative reagent gas ions are trapped in the ion trap in priority. Thereafter, when negative reagent gas ions and specimen gas are reacted with each other during the ionization period of specimen gas by CI, negative specimen gas ions are generated and negative specimen gas ions are sequentially subjected to mass analysis during the mass analysis scan period. Here, as indicated by a solid line in FIG. 24, the DC voltage U during the mass analysis scan period is set to 0 and the ordinary mass analysis scan method may be used or as indicated by a dashed line in FIG. 24, the value may be skipped so as to keep U/V_{RF} constant. Next, the effect of this embodiment will be indicated using the results actually obtained by numerical analysis.

A case that methane (CH₄) is used as reagent gas is adopted. Main negative reagent gases generated when methane is ionized by EI are shown below.

Negative reagent gases of methane: C₂H⁻, C₂⁻, C⁻

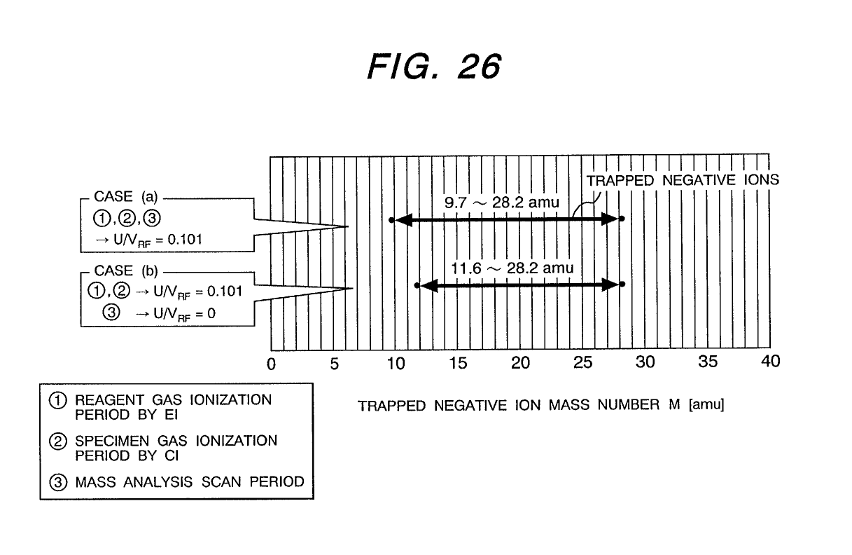

The mass range of the aforementioned negative reagent gases is 12 amu to 25 amu. Therefore, during the ionization period of reagent gas by EI, it is desirable to eject all positive reagent gas ions and with respect to negative reagent gas, trap negative ions at least within the mass range from 12 amu to 25 amu. Accordingly, the ratio (U/V_{RF}) of DC voltage U to RF drive voltage amplitude V_{RF} is fixed to 0.101 and then the DC voltage U and the RF drive voltage amplitude V_{RF} are adjusted so as to include negative ions within the mass range from 12 amu to 25 amu in the stability region of negative ions. For the set value of the DC voltage U during the mass analysis scan period, in the two cases that (a) U=0 and (b) U/V_{RF}=constant are set, the ion orbit in the ion trap is analyzed and the mass range of ions stably trapped is obtained. In this case, as shown in FIG. 25, the operation line is positioned outside the stability region of positive ions, so that it is found that positive ions are all ejected and do not exist within the mass range of trapped ions. The mass range obtained for negative ions is shown in FIG. 26. It is found that in both cases (a) and (b), the mass range of trapped negative ions can cover the mass range (12 amu to 25 amu) of negative reagent gas of methane. Therefore, according to this embodiment, positive reagent gas ions generated in a large amount during ionization of reagent gas can be ejected from the ion trap and negative reagent gas ions can be trapped in priority, so that CI negative ions generated by reaction of negative reagent gas ions and specimen gas can be subjected to mass analysis by the ion trap mass spectrometer of an internal ionization type.

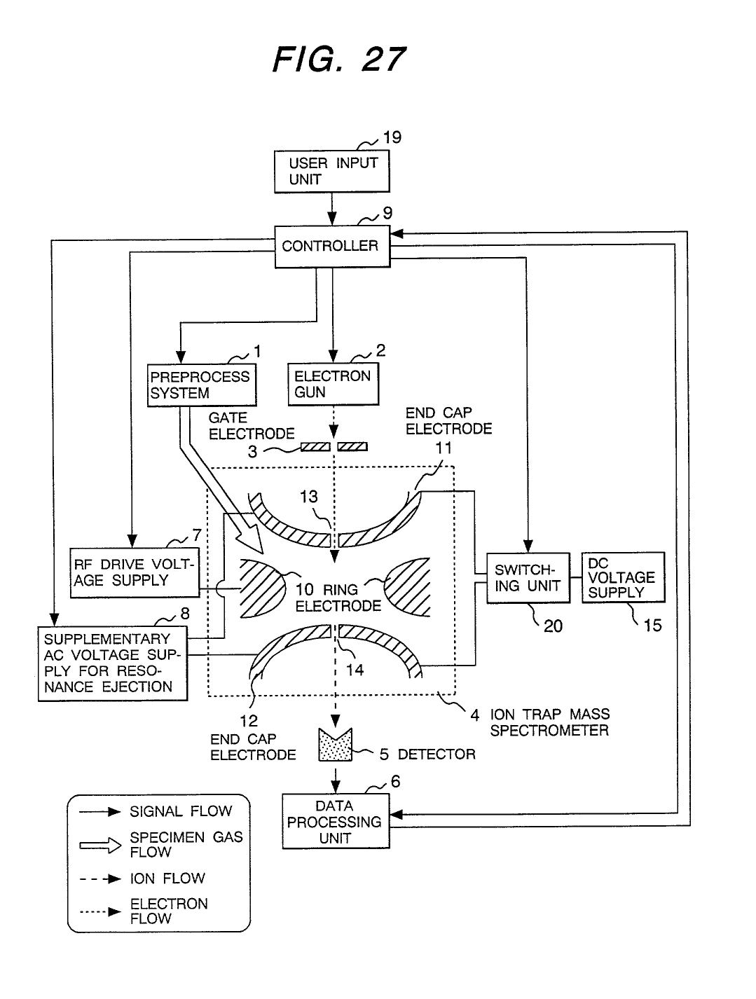

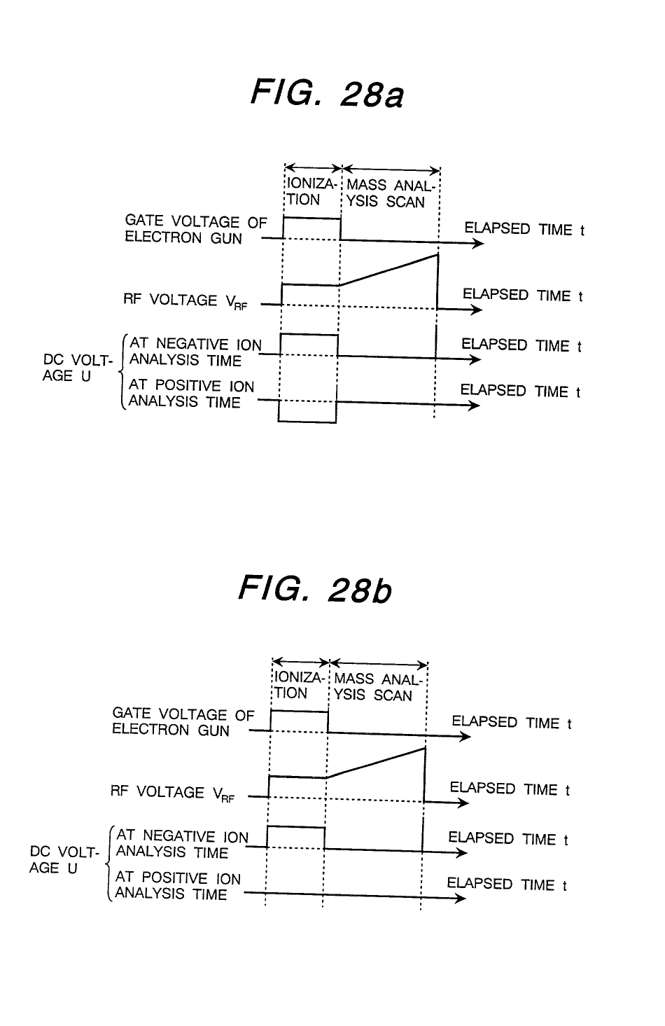

The seventh embodiment of the present invention will be explained hereunder by referring to FIGS. 27, 28(a), and 28(b). FIG. 27 is a schematic view of the whole ion trap mass spectrometer of this embodiment. This embodiment is characterized in that a user input unit 19 sets the DC voltage U to be applied between the two end cap electrodes 11 and 12 from the DC voltage supply 15 during the ionization period to a most suitable value by the controller 9 according to the ion polarity (positive or negative) to be analyzed which is input by a user. As shown in FIG. 28(a), for the DC voltage U to be applied during the ionization period, when negative ions are to be analyzed, a positive value (U>0) is applied and when positive ions are to be analyzed, a negative value (U<0) is applied. In this case, as shown in FIG. 27, a DC voltage is applied via a switching unit 20 for switching the sign of the DC voltage to be applied during the ionization period according to the ion polarity. Or, the DC voltage U to be applied during the ionization period when positive ions are to be analyzed may be set to zero (U=0) as shown in FIG. 28(b). In this case, in place of the switching unit 20, turning the DC voltage on or off is controlled by the controller 9 depending on the polarity of ions to be mass-analyzed. Therefore, according to this embodiment, by an internal ionization type ion trap mass spectrometer, not only mass analysis of negative ions is made possible but also mass analysis of positive and negative ions is made possible. From the aforementioned, for example, in an internal ionization type ion trap mass spectrometer, during ionization by an electron impact in the ion trap, positive ions generated in a large amount can be ejected from the space between the ion trap electrodes simultaneously with ionization, so that negative ions generated in an extremely small amount are trapped in priority and mass analysis of negative ions is made possible.

According to the present invention, in an ion trap mass spectrometer of an internal ionization type, an ion trap mass spectrometry method and its apparatus for enabling mass analysis of negative ions can be provided.

What is claimed is:

1. An ion trap mass spectrometer comprising
an annular ring electrode;
two end cap electrodes arranged in an opposite direction so as to hold said ring electrode;
a radio frequency (RF) power supply for generating an RF voltage to be applied between said ring electrode and said end cap electrodes so as to generate an RF field in a space formed between said ring electrode and said end cap electrodes;
internal ionization means for generating ions in said inter-electrode space between said ring electrode and said end cap electrodes;
means for trapping said generated ions in said inter-electrode space generated by said RF field;
a detector for sequentially mass-separating said trapped ions in said inter-electrode space according to a mass-to-charge ratio of said ions, ejecting from said inter-electrode space, and detecting said ions; and
an application device for superimposing a DC field in said inter-electrode space in addition to said RF field.

2. An ion trap mass spectrometry method including any of following processes:
process (1): superimposing a static field between ion trap electrodes in addition to an RF field during an ionization period and ejecting positive ions from said space between said ion trap electrodes simultaneously with ionization;
process (2): additionally superimposing a supplementary AC field between said ion trap electrodes in addition to said RF field and said static field during said ionization period and ejecting positive ions from said space between said ion trap electrodes simultaneously with ionization; and
process (3): setting a magnitude of said static field to be applied during said ionization period depending on polarity (positive or negative) of ions to be subjected to mass analysis.

3. An ion trap mass spectrometry method for superimposing a static field to an annular ring electrode, two end cap electrodes arranged in an opposite direction so as to hold said ring electrode, and an inter-electrode space formed between said ring electrode and said end cap electrodes in addition to an RF field, ejecting positive ions from said inter-electrode space, trapping negative ions in priority, and then when sequentially mass-separating said negative ions according to a mass-to-charge ratio of said negative ions, ejecting positive ions from said inter-electrode space during a period that ions are generated in said inter-electrode space.

4. An ion trap mass spectrometry method according to claim 3, wherein said method superimpose a DC voltage between said ring electrode and said end cap electrodes in addition to an RF voltage, thereby generates said RF field and said static field in said inter-electrode space.

5. An ion trap mass spectrometry method according to claim 4, wherein said method applies an RF voltage to said ring electrode and a DC voltage having a same magnitude to said two end cap electrodes respectively.

6. An ion trap mass spectrometry method according to claim 4, wherein said method applies an RF voltage and a DC voltage to said ring electrode and sets said two end cap electrodes at a grounding voltage.

7. An ion trap mass spectrometry method according to claim 3, wherein said method changes said static field to be superimposed according to polarity of an ion charge necessary for mass analysis, ejects ions having polarity opposite to said polarity of said ion charge necessary for mass analysis, traps ions necessary for analysis in priority, thereafter sequentially mass-separates said ions according to said mass-to-charge ratio, thereby mass-analyzes both positive and negative ions.

8. An ion trap mass spectrometry method according to claim 7, wherein said method sets a DC voltage to be applied between said ring electrode and said end cap electrodes according to said polarity of ions necessary for mass analysis, thereby mass-analyzes both positive and negative ions.

9. An ion trap mass spectrometry method according to claim 7, wherein said method switches a sign of a DC voltage to be applied between said ring electrode and said end cap electrodes according to said polarity of ions necessary for mass analysis.

10. An ion trap mass spectrometry method according to claim 5 or 8, wherein when said method applies said RF voltage to said ring electrode and said DC voltage having a same magnitude to said two end cap electrodes respectively and sets said DC voltage to be applied to said end cap electrodes according to said polarity of ions necessary for mass analysis, if said ions necessary for mass analysis are negative ions, said method applies a positive DC voltage to said end cap electrodes and if said ions necessary for mass analysis are positive ions, said method applies a negative DC voltage or a DC voltage of zero to said end cap electrodes.

11. An ion trap mass spectrometry method according to claim 3, wherein said method additionally superimposes a supplementary AC field at a frequency lower than that of said RF field between said inter-electrode space during a period of ejecting positive ions.

12. An ion trap mass spectrometry method according to claim 10, wherein a supplementary AC field at a frequency lower than that of said RF field is a plurality of supplementary AC fields having different frequency ingredients.

13. An ion trap mass spectrometry method according to claim 11, wherein said method applies supplementary AC voltages at a frequency lower than that of said RF field in an opposite phase each other to each of said two end cap electrodes.

14. An ion trap mass spectrometry method according to claim 11, wherein said method applies supplementary AC voltages at a frequency lower than that of said RF field in a same phase to each of said two end cap electrodes.

15. An ion trap mass spectrometry method according to claim 12, wherein said method applies a supplementary AC voltage at a frequency lower than that of said RF field to said ring electrode.

16. An ion trap mass spectrometry method according to claim 3, wherein when mass-analyzing specimen gas ions generated by so-called chemical ionization that reagent gas flows into said inter-electrode space formed by said ring electrode and said end cap electrodes, and said reagent gas collides with electrons injected into said inter-electrode space, ionizes, and generates reagent ions, and said reagent ions and neutral specimen gas molecules flowing into said inter-electrode space react each other so as to ionize said specimen gas, said method superimposes a static field in said inter-electrode space, thereby ejects positive reagent ions among said reagent ions from said inter-electrode space, traps negative reagent ions in priority, and then mass-analyzing negative specimen gas ions generated by reacting said negative reagent ions and said specimen gas.

17. An ion trap mass spectrometry method according to claim 16, wherein said method superimposes said static field in said inter-electrode space during a period of generation of reagent ions and ejects positive reagent ions.

18. An ion trap mass spectrometry method according to claim 16, wherein said method sets magnitudes of said RF field and said static field and further when superimposing a supplementary AC field, a magnitude and frequency of said supplementary AC field so as to trap reagent ion species functioning for chemical ionization of at least said specimen gas among said negative reagent ions in said inter-electrode space.

19. An ion trap mass spectrometer comprising an annular ring electrode, two end cap electrodes arranged in an opposite direction so as to hold said ring electrode, a radio frequency (RF) power supply for generating an RF voltage to be applied between said ring electrode and said end cap electrodes so as to generate an RF field in a space formed between said ring electrode and said end cap electrodes, internal ionization means for generating ions in said inter-electrode space between said ring electrode and said end cap electrodes, a detector for detecting ions existing in said inter-electrode space, and a switching unit for switching polarity of a DC field applied in said inter-electrode space.

20. An ion trap mass spectrometer comprising an annular ring electrode, two end cap electrodes arranged in an opposite direction so as to hold said ring electrode, a radio frequency (RF) power supply for generating an RF voltage to be applied between said ring electrode and said end cap electrodes so as to generate an RF field in a space formed between said ring electrode and said end cap electrodes, internal ionization means for generating ions in said inter-electrode space between said ring electrode and said end cap electrodes, a detector for detecting ions trapped in said inter-electrode space, and an application device for superimposing a DC voltage and a supplementary AC voltage in said inter-electrode space.

21. An ion trap mass spectrometer according to any of claims 1, 19, and 20, wherein said spectrometer has a controller for setting variably, in said negative reagent ions, a magnitude of said RF field, a magnitude of said DC field, and/or when superimposing a supplementary AC field, a magnitude and/or frequency of said supplementary AC field.
